(19) United States
(12) Patent Application Publication
(10) Pub. No.: US 2004/0128255 A1
(43) Pub. Date: Jul. 1, 2004

(54) Payment system and method for e-commerce via digital broadcasting

(76) Inventor: Dong-Su Jung, Anyang-Si (KR)

Correspondence Address: Law Offices, Jacobson Holman, 400 Seventh Street, N.W., Washington, DC, 20004-2218, US

(21) Appl. No.: 10/329,747

(22) Filed: Dec. 27, 2002

(51) Int. Cl. G06F 17/60

(52) U.S. Cl. 705/65

(57) ABSTRACT

Disclosed herein is a payment system and method for e-commerce via digital broadcasting. The payment system performs payment when transaction is conducted in response to a commodity purchase request while watching a digital broadcasting program. The payment system includes a digital broadcasting terminal, a program provider, an e-payment gateway, a Value Added Network (VAN) company and a financial company. The digital broadcasting terminal includes an e-wallet for storing client and payment information and a drive application for driving the e-wallet. The program provider includes a digital broadcasting and Internet connection supporting server and a client tool kit for an e-payment gateway. The e-payment gateway operates in conjunction with the client tool kit and requests transaction approval from a VAN company. The VAN company queries a financial agency about whether transactions can be approved through a value added network. The financial agency determines whether transactions are approved in response to a query request of the VAN company and transfers money for payment.

### BACKGROUND OF THE INVENTION

1. Field of the Invention

The present invention relates to a payment system for e-commerce via digital broadcasting, which is capable of conveniently and securely performing payment when transaction is conducted in response to a commodity purchase request while a user watches a digital broadcasting program capable of supporting e-commerce through duplex data communication using a digital broadcasting terminal.

2. Description of the Prior Art

Broadcasting may be classified as terrestrial, satellite or cable broadcasting according to the manner of transmitting information. Terrestrial broadcasting is broadcasting in which electric waves are transmitted from a transmitting tower of a broadcasting station to antennas of a receivers through the air, and is performed by such companies as the Korean Broadcasting System (KBS), the Munhwa Broadcasting Corporation (MBC) and the Seoul Broadcasting System (SBS) of Korea, the American Broadcasting Company (ABC) and the National Broadcasting Company (NBC) of U.S., the British Broadcasting Corporation of the United Kingdom, and the Nippon Hoso Kyokai (NHK, Japan Broadcasting Corporation) of Japan. Satellite broadcasting is broadcasting in which the electric waves transmitted from a broadcasting station are received by antennas of receivers through a satellite, and is performed by such companies as KBS and the Korea Educational Broadcasting System of Korea through Koreasat, the BS and CS satellite broadcasting of Japan, Star TV of Hong Kong and BskyB of Europe. Cable broadcasting is broadcasting in which electric waves are transmitted from a broadcasting station to receivers through cables, and is performed by the Cable News Network (CNN) of U.S. and the various cable broadcasting companies of Korea.

Also, broadcasting may be classified as analog or digital broadcasting. Analog broadcasting is broadcasting in which broadcasting signals including images and voices are electrically changed and transmitted in continuous waveforms. Digital broadcasting is broadcasting, in which an overall broadcasting process including production of programs, transmission and reception is processed in a digital manner wherein time is divided into minute time segments, the state of amplitude within a time segment is represented by a binary digit “0” or “1” and the size of information is changed according to the amount of combined binary digits, which has no impairment and no noise. Recently, broadcasting has been changed from analog broadcasting to digital broadcasting in that satellite broadcasting and cable broadcasting employ digital broadcasting and the employment of digital broadcasting in the terrestrial broadcasting has been tested in some areas.

Such digital broadcasting has multichannel, high quality and multifunctional features. The multichannel broadcasting is currently available through digital satellite broadcasting provided by DirectTV of U.S. and SkyPerfecTV of Japan. Additionally, users can experience the high quality feature of digital broadcasting in which information can be restored without loss of quality due to the digital processing of broadcasting signals and definite picture and sound quality compared to analog broadcasting is provided due to noise-free processing, through high definition television broadcasting having being tested. The multifunctional feature of digital broadcasting means that various services can be provided using a data channel as well as image and sound channels, and is the most important feature that renders digital broadcasting most different from analog broadcasting. In this aspect digital broadcasting may be referred to as digital data broadcasting. That is, in digital broadcasting, with the development of multiplexing technology, image, sound and data can be transmitted at the same time regardless of contents and sizes, a return channel is generated through a modem so that interactive services are provided, and the installation of a processor and an operating system allows various reception functions. With the aid of the development of technology, digital data broadcasting provides multimedia services to users beyond the limitation in the added services of conventional analog data broadcasting. Digital broadcasting services can provide data as well as image and sound, so users can be easily provided with desired information services, thus promoting the information-oriented home. For example, while a user watches a sports game, the user not only watches various data of a favorite player, but also watches pictures photographed from various angles at the same time or sequentially. For a TV drama, while a user watches it, he can obtain information on the plot or location of the drama.

In particular, digital broadcasting has a multifunctional feature, that is, digital broadcasting enables bi-directional transmission, so e-commerce is enabled through a TV. For example, home shopping is performed through a TV in such a way that while a user watches a TV drama, icons are displayed on items, such as accessories, on a screen and the user clicks on one or more icons with a mouse or remote controller. In the case of home shopping via cable broadcasting, orders can be issued by clicking a button of a mouse or remote controller instead of making a phone call, so convenient home shopping can be achieved.

As various e-commerce is enabled through digital broadcasting, a convenient and secure payment system is required at the time of e-commerce transaction. Although various technologies on payment systems for conventional online e-commerce via the Internet are disclosed, the conventional technologies do not provide payment systems for e-commerce via digital broadcasting. Therefore, the conventional technologies are problematic in that they are not effectively applied to payment for e-commerce via digital broadcasting.

### SUMMARY OF THE INVENTION

Accordingly, the present invention has been made keeping in mind the above problems occurring in the prior art, and an object of the present invention is to provide a payment system and method for e-commerce via digital broadcasting, which is capable of easily, conveniently and securely making payment for e-commerce via digital broadcasting.

In order to accomplish the above object, the present invention provides a payment system for e-commerce via digital broadcasting, the payment system performing payment when transactions are conducted in response to a commodity purchase request while watching a digital broadcasting program capable of supporting e-commerce through duplex data communication, comprising a digital broadcasting terminal comprising an e-wallet for storing client and payment information, and encrypting and transmitting the client and payment information at the time of transaction and a drive application for driving the e-wallet, and performing duplex data communication with a program provider; a program provider comprising a digital broadcasting and Internet connection supporting server for receiving client and payment information transmitted from the e-wallet and performing Internet connection when a commodity purchase request is issued, and a client tool kit for an e-payment gateway for performing connection to an e-payment gateway, transmitting information and receiving approval results from the e-payment gateway, an e-payment gateway for performing connection to the Internet, operating in conjunction with the client tool kit, and requesting transaction approval from a Value Added Network (VAN) company, receiving approval results from a VAN company, and transmitting the approval results to the program provider, and a VAN company for querying a financial agency about whether transactions can be approved through a value added network, transmitting query results to the e-payment gateway, receiving a money transfer request from the e-payment gateway and requesting the money transfer for the card transaction from the financial agency, and a financial agency for determining whether transactions are approved in response to a query request of the VAN company, transmitting query results to the VAN company, and transferring money for payment.

In addition, the present invention provides a payment method using the payment system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a construction of a payment system for e-commerce via digital broadcasting in accordance with the present invention; and

FIG. 2 is a flowchart showing steps of a payment method for e-commerce via digital broadcasting in accordance with the present invention.

### DESCRIPTION OF THE PREFERRED EMBODIMENTS

Reference now should be made to the drawings, in which the same reference numerals are used throughout the different drawings to designate the same or similar components.

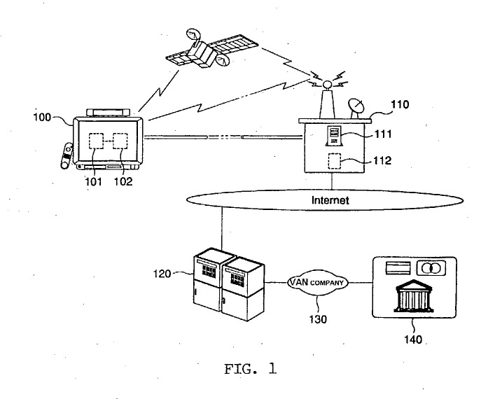

FIG. 1 is a diagram showing a payment system for e-commerce via digital broadcasting in accordance with the present invention.

Referring to the drawing, the payment system of the present invention includes a digital broadcasting terminal 100, a program provider 110, an e-payment gateway 120, a Value Added Network (VAN) company 130 and a financial agency 140.

The terminal 100 can include a digital TeleVision (TV), an analog TV equipped with a set-top box for reception of digital broadcasting, a Personal Computer (PC) equipped with a TV card for reception of digital broadcasting, etc.

The digital TV may be classified as a High Definition (HD) or Standard Definition (SD) TV according to the quality of image and voice. The HD TV supports significantly more definite image and voice compared to a conventional analog TV. That is, the RD TV provides the picture quality of 35 mm movies with the sound quality of Dolby Digital 5.1, so users can view digitalized images of high picture and sound quality. In particular, when the feature of high resolution is sufficiently utilized, the HD TV can be applied to various fields of industry such as medical industry and defense industry. The SD TV provides resolution higher than that of the conventional analog TV (for example, a National Television Systems Committe (NTSC) type TV and a Phase Alternation Line (PAL) type TV) and lower than that of the HD TV. The HD TV focuses on high picture and sound quality, while the SD TV focuses on plural channels and added services and provides lower picture and sound quality. Accordingly, the SD TV is advantageous in that it can easily carry various contents, such as education, entertainment, e-commerce, interactive TV, e-mail, Video On Demand (VOD), World Wide Web (WWW), etc. on its extra band The transmission stream of the HD/SD TV is divided into video, audio and data parts. For ATSC standards, MPEG 2 and Dolby Audio Coding (AC)-3 are preferably adopted as video and audio standards, respectively. The Dolby AC-3 has a standard sampling rate of 48 KHz and is represented through 5.1 channels, which may be implemented by five surround speakers and one woofer. A transmission subsystem may comprise a packet that is comprised of a 4-byte header and a 184-byte payload. A Radio Frequency (RF) modulation method is 8 Vestigial Side Bands (VSB) modulation method, in which for a 6 MHz terrestrial channel, data can be preferably received at 19.3 Mbps. The decoding unit of a typical HD/SD TV is divided into a demodulator for separating digital signals from analog carriers, a demultiplexer for separating audio signals from video signals, an image decoder for restoring encoded signals, and an audio decoder for restoring encoded audio signals. A packet structure is one of characteristics that distinguishes an analog broadcasting signal from a digital broadcasting signal. A HDTV signal comprises packets, each of which consists of a header and a descriptor. These digital characteristics are significantly advantageous in that they allow various digital devices to have compatible and expandable. The employment of Moving Pictures Expert Group (MPEG) 2 in the encoding and decoding of picture and sound is advantageous in that it allows various resolutions and picture ratios.

In the case where an existing conventional analog TV is used as the terminal 100, the existing conventional analog TV has to be equipped with a digital broadcasting receiver, that is, a set-top box, which allows the existing conventional analog TV to be utilized.

In the case where an existing PC is used as the terminal 100, the existing PC has to be equipped with a digital TV reception card. This scheme is advantageous in that the cost of equipment is inexpensive compared to the HD TV or analog TV equipped with the set-top box and a high picture quality similar to that of SD TV.

The terminal 100 of the present invention is provided with an e-wallet 101 and a drive application 102.

The e-wallet 101 is a program that receives a user's client and payment information for e-commerce via digital broadcasting from a client and stores it, and encrypts it and transmits it to the program provider 110 at the time of transaction. The client information includes name, social security number, address and shipping information, etc., and the payment information includes credit card number, valid period for a credit card, and a password for a credit card number. The e-wallet 101 may be an embedded type e-wallet embedded in the terminal 100, a downloaded type e-wallet downloaded from the program provider 110 through data communication and installed in the terminal 100, a sever type e-wallet stored in a server of the program provider 110 and used at the time of transaction, and a terminal-server type e-wallet in which minimum information required for payment is stored in the terminal 100 and remaining information is stored in a server of the program provider 110.

The drive application is software that is used to drive the e-wallet 101 at the time of transaction. At the time of transaction, the drive application 102 drives the e-wallet 101, the user information including credit card information stored in the driven e-wallet 101 is encrypted and transmitted to the program provider 110 by the terminal 100 capable of duplex communication, and an approval result for a credit card transaction request is transmitted to the terminal 100 by the program provider 110.

The payment system of the present invention includes the program provider 110. The program provider 110 may be a terrestrial, satellite or cable broadcasting station. The terrestrial broadcasting station is connected with the terminal 100 by electric waves though the air, the cable broadcasting station is connected with the terminal 100 by electric waves through a satellite, and the cable broadcasting station is connected with the terminal 100 by electric waves through a cable. The program provider 110 broadcasts programs that support e-commerce. In particular, of cable broadcasting stations, home shopping stations mainly broadcast e-commerce TV programs.

The program provider 110 is provided with a digital broadcasting and Internet connection supporting server that transmits digital broadcasting to the terminal 100, exchanges data with the terminal 100 and supports Internet connection to the e-payment gateway 120.

When a purchase request is issued by the terminal 100, the server 111 functions to receives user information including credit card information transmitted from the e-wallet 101 driven by the drive application 102 and connect the program provider 110 to the Internet.

The program provider 110 is provided with a client tool kit for an e-payment gateway 112. The client tool kit 112 is a solution that serves to connect the program provider 110 through the Internet, transmit user information to the c-payment gateway 120, and receive a credit card transaction approval result from the e-payment gateway 120.

In addition, the program provider 110 is provided with a commodity DataBase (DB, not shown) that has previously stored commodity information. That is, for a TV drama, information on all commodities, such as accessories, which are displayed on a screen and provided for e-commerce, is previously stored in the commodity DB and the commodity DB may be operated in conjunction with a program transmitting unit (not shown). On the basis of the commodity DB and the conjunctive operation, there can be provided bi-directional home shopping via digital broadcasting in such a way that a user of the terminal 100 moves an icon onto a certain commodity on the screen of a TV by the manipulation of a mouse or remote controller and clicks on the certain commodity with the mouse or remote controller to transmit selection data to the program provider 110, the program provider 110 searches the commodity DB for information on the certain commodity and transmits the searched information to the terminal 100, and the user of the terminal 100 reads the transmitted information and transmits order information to the program provider 100 by the manipulation of the mouse or remote controller.

Further, the payment system of the present invention includes the e-payment gateway 120. The e-payment gateway 120 is a virtual credit card checker implemented in the software, which serves to allow credit cards to be securely used in cyber shopping malls at the time of transaction in the same manner that credit card transactions are processed through a credit card check in offline shopping malls. The e-payment gateway 120 is connected with the program provider 110 through the Internet, connected with the VAN company 130 through the VAN, connected with the financial agency 140 through the VAN company 130, and operated in conjunction with the client tool kit 112. The e-payment gateway 120 can be constructed so that it processes credit card related businesses including purchase businesses, settlement businesses as well as credit card transaction approval businesses on behalf of the shopping mall. Internet connection between the program provider 110 and the e-payment gateway 120 can be implemented in both wired and wireless manners, so the e-payment gateway 120 of the present invention comprises a wired or wireless Internet access system.

Additionally, the payment system of the present invention includes the VAN company 130. The VAN company queries the financial agency 140 about whether a card transaction can be approved through a VAN and transmits the query results to the e-payment gateway 120, and receives a money transfer request from the e-payment gateway 120 and requests the money transfer for the card transaction from the financial agency 140.

Additionally, the payment system of the present invention includes the financial agency 104. The financial agency 140 determines whether a card transaction is approved in response to a query request of the VAN company 130, transmits the query results to the VAN company 130, and transfers money for payment to the e-payment gateway 120 or a cybermall of the program provider 110.

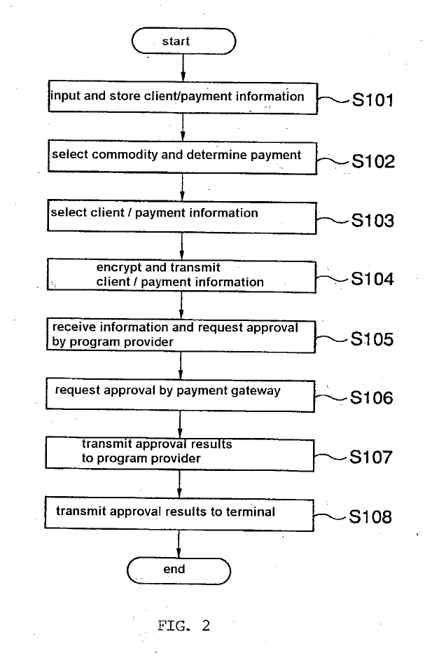

A payment method for e-commerce via digital broadcasting is described by the step below. FIG. 2 is a flowchart showing the steps of the payment method of the present invention.

Referring to FIG. 2, a user inputs the client and payment information to the e-wallet 101 of the terminal 100, and the e-wallet 101 encrypts the client and payment information and stores it in a memory of the terminal 100 at step S101. In this case, the user may input a piece of client information and a piece of payment information. Alternatively, since the user can may a plurality of credit cards and/or a plurality of shipping addresses, the user may input plural pieces of client information and/or plural pieces of payment information and select some of them as occasion demands.

The program provider 110 provides to the terminal 100 a program, such as a home shopping program, which supports e-commerce, and the user selects some of commodities provided for e-commerce by the program and determines payment using the duplex data communication function of the terminal 100 at step S102.

Then, the drive application 102 of the terminal 100 drives the e-wallet 101, and the user selects some of client and payment information stored in the e-wallet 101 at step S103. In the case where a piece of client information and a piece of payment information are stored in the e-wallet 101, step S103 may be constructed so that the piece of client information and the piece of payment information are automatically used without any selection.

Thereafter, the e-wallet 101 of the terminal 100 encrypts selected client and payment information and transmits it to the program provider 110 using a duplex data communication function of the terminal 100 at step S104.

Subsequently, the program provider 110 receives the client and payment information, connects with the Internet using the server 111, and requests approval for payment from the e-payment gateway 120 using the client tool kit 112 at step S105.

Thereafter, the e-payment gateway 120 requests approval for payment from the financial agency 140 through the VAN company 130 at step S106.

At step S107, the financial agency 140 processes the approval request in such a way as to issue approval particulars and an approval number the case of a valid approval request and a refusal to approval in the case of an invalid approval request, and transmits processed results to the e-payment gateway 120 through the VAN company 130, and the e-payment gateway 120 transmits the processed results to the program provider 110.

Thereafter, the program provider 110 transmits the processed results to the terminal 100 at step S108.

As described above, the present invention provides a payment system and method for e-commerce via digital broadcasting, which is capable of easily, conveniently and securely making payment for e-commerce via digital broadcasting.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A payment system for e-commerce via digital broadcasting, the payment system performing payment when transaction is conducted in response to a commodity purchase request while watching a digital broadcasting program capable of supporting e-commerce through duplex data communication, comprising:
a digital broadcasting terminal comprising an e-wallet for storing client and payment information, and encrypting and transmitting the client and payment information at the time of transaction and a drive application for driving the e-wallet, and performing duplex data communication with a program provider;
a program provider comprising a digital broadcasting and Internet connection supporting server for receiving client and payment information transmitted from the e-wallet and performing Internet connection when a commodity purchase request is issued, and a client tool kit for an e-payment gateway for performing connection to an e-payment gateway, transmitting information and receiving approval results from the e-payment gateway;
an e-payment gateway for performing connection to the Internet, operating in conjunction with the client tool kit, and requesting transaction approval from a Value Added Network (VAN) company, receiving approval results from a VAN company, and transmitting the approval results to the program provider; and
a VAN company for querying a financial agency about whether transactions can be approved through a value added network, transmitting query results to the e-payment gateway, receiving a money transfer request from the e-payment gateway and requesting the money transfer for the card transaction from the financial agency; and
a financial agency for determining whether transactions are approved in response to a query request of the VAN company, transmitting query results to the VAN company, and transferring money for payment.

2. The payment system as set forth in claim 1, wherein the program provider is provided with a commodity DataBase (DB) that has previously stored commodity information.

3. The payment system as set forth in claim 1 or 2, wherein the digital broadcasting terminal is one of a digital TeleVision (IV), an analog TV equipped with a set-top box for reception of digital broadcasting and a person computer equipped with a TV card for reception of digital broadcasting.

4. The payment system as set forth in claim 1 or 2, wherein the digital TV is a High Definition (HD) TV or Standard Definition (SD) TV.

5. The payment system as set forth in claim 1 or 2, wherein the e-wallet is one of an embedded type e-wallet, a downloaded type e-wallet, a server type e-wallet and a terminal-server type e-wallet.

6. A payment method for e-commerce via digital broadcasting, the payment method performing payment when transactions are conducted in response to a commodity purchases request while watching a digital broadcasting program capable of supporting e-commerce through duplex data communication, comprising the steps of:
a user inputting one or more pieces of client information and one or more pieces of payment information in an e-wallet of a digital broadcasting terminal, and the e-wallet encrypting the client and payment information and storing the client and payment information in a memory of the terminal;
a program provider providing a program capable of supporting e-commerce to the terminal, and the user selecting at least one of commodities provided for e-commerce by the program and determining payment using duplex data communication function of the terminal;
a drive application of the terminal driving the e-wallet, and the user selecting some of the client and payment information stored in the e-wallet;
the terminal encrypting the selected client and payment information and transmitting the encrypted client and payment information to the program provider using duplex data communication function of the terminal;
the program provider receiving the client and payment information using the server and accessing the Internet using a digital broadcasting and Internet connection supporting server, and requesting payment approval from the e-payment gateway using a client tool kit for an e-payment gateway;
the e-payment gateway requesting the payment approval from a financial company through a VAN company;
the financial company processing the payment approval request and transmitting processed results to the e-payment gateway, and the e-payment gateway transmitting the processed results to the program provider; and
the program provider transmitting the processed results to the terminal.

7. The payment method as set forth in claim 6, wherein the step of selecting the commodities comprises the steps of:
transmitting information on the commodities selected by user's manipulating of a mouse or remote controller from the terminal to the program provider;
the program provider searching a commodity DB previously storing commodity information for the selected commodities and providing the searched information to the terminal; and
transmitting information on an order issued by user's manipulating of a mouse or remote controller from the terminal to the program provider.

8. The payment method as set forth in claim 6 or 7, wherein the digital broadcasting terminal is one of a digital TeleVision (IV), an analog TV equipped with a set-top box for reception of digital broadcasting and a person computer equipped with a TV card for reception of digital broadcasting.

9. The payment method as set forth in claim 6 or 7, wherein the digital TV is a High Definition (HD) TV or Standard Definition (SD) TV.

10. The payment method as set forth in claim 6 or 7, wherein the e-wallet is one of an embedded type e-wallet, a downloaded type e-wallet, a server type e-wallet and a terminal-server type e-wallet.

11. The payment method as set forth in claim 6 or 7, wherein when a piece of client information and a piece of payment information are stored in the e-wallet, the piece of client information and the piece of payment information are automatically used without any selection.
